(19) United States
(12) Patent Application Publication
(10) Pub. No.: US 2023/0406586 A1
(43) Pub. Date: Dec. 21, 2023

(54) COMPOSTABLE STORAGE BAG

(71) Applicant: Northwest IP Holdings, LLC, Clackamas, OR (US)

(72) Inventor: Adam Gysin, Clackamas, OR (US)

(73) Assignee: Northwest IP Holdings, LLC, Clackamas, OR (US)

(21) Appl. No.: 17/841,484

(22) Filed: Jun. 15, 2022

(51) Int. Cl. B65D 65/46; B65D 33/25; B65D 65/40; B32B 27/36; B32B 23/08

(52) U.S. Cl. CPC B65D 65/466; B65D 33/2508; B65D 65/40; B32B 27/36; B32B 23/08; B32B 2439/46; B32B 2307/7163; B32B 2250/02; B32B 2307/732; B32B 2307/31

(57) ABSTRACT

Biodegradable and compostable materials and zipper formed into a closable bag, which is biodegradable in a home composting environment. The material is preferentially free from ingredients which are more burdensome to the environment to manufacture.

### CROSS REFERENCE TO RELATED APPLICATIONS

Not applicable.

### BACKGROUND OF THE INVENTION

None.

### SUMMARY OF THE INVENTION

The present disclosure is directed to a biodegradable and compostable material formed into storage bags, which may be compostable in a home environment.

Biodegradable packaging is an alternative to plastic that helps alleviate the long term issues presented by excessive plastic usage. Biodegradable packaging is made of renewable materials, whereas plastics are made of oil. Biodegradable packaging is presented as non-toxic to natural environments or humans.

Consumers often falsely assume that all such biodegradable packaging which is placed in a recycling bin is recycled. This is far from the truth, as over 90 percent of recycled packaging ends up in landfills. It is difficult to assess the success rate of industrial composing facilities that accept a variety of biopolymers. Industrial composting facilities boast special equipment for mechanically breaking down packaging into smaller sized material. They may be mixed with other animal products.

There is a need for packaging which is compostable in a home compositing environment and is also suitable for use as containers, bags, and films.

### BRIEF DESCRIPTION OF THE DRAWINGS

For a better understanding of the disclosure, and to show how the same may be carried into effect, reference will now be made, by way of example to the accompanying drawings, which:

FIG. 1 shows a perspective view of an embodiment of the present disclosure;

### DETAILED DESCRIPTION

The present disclosure is directed to a biodegradable and compostable material formed into containers, which may be compostable in a home environment. Such compostable packaging could be used to store consumables and cosmetics, sometimes within other containers. Such compostable bags are preferably strong, flexible, and resistant to temperature or moisture change, making them excellent for long term storage or for products that are shipped extended distances.

“Biodegradables”, according to the American Society for Testing and Materials (ASTM), are anything that undergoes degradation resulting from the action of naturally occurring microorganisms such as bacteria, fungi, and algae. “Compostables”, according to the ASTM, are products capable of breaking down into natural elements in a compost environment. The ASTM defines compostables as anything that undergoes degradation by biological processes during composting to yield CO2, water, inorganic compounds and biomass at a rate consistent with other compostable materials and leaves no visible, distinguishable or toxic residue.

European Standard EN 13432 sets criteria for what can or cannot be described as compostable and what can be called biodegradable. The US Standard ASTM D6400-99 also sets out similar standards.

Biodegradable packaging is produced using biopolymers, which are molecules often found in living organisms, like cellulose and proteins. This frequently means they can be safely consumed, degrade quickly, and can even be created from waste plant products.

The biopolymers used in biodegradable packaging are produced in a few different ways, but usually in a process which requires much less energy than the production of plastic polymers. One of the most common production methods is extracting them directly from plant matter. Starch based packaging is arguably the most common type of biopolymer produced from green plants, like potatoes, corn, rice, etc., which are heated and starch molecules directly extracted from them. The starch biopolymers are then processed, heated, and turned into a final package shape. Starch is a very accessible and low cost biopolymer. Starch based polymers have been proven to successfully replace polystyrene and polyethylene plastics.

Another common biopolymer often used in conjunction with starch is chitin. Chitin is commonly found in the skin of insects, cell walls of fungi, and shells of shellfish. Biodegradable films are commonly made with a mix of starch and chitin as they have been shown to have good antimicrobial properties. These films are used in food packaging and as an edible coating for fruits and vegetables. The starch-chitin based coatings work well in conjunction with metal packaging, as they coat perishables and prevent them from coming into contact with air.

Not all biopolymers can be composted at home and require special composting facilities to be effectively composted.

Presented herein is a novel laminate composition to be used in manufacture of a storage bags with a zipper closure. The first layer of the laminate is a high barrier heat-sealable compostable film which is biodegradable and compostable, and made from renewable resources. Natureflex NK® is one such suitable film. The first layer is suitable for printing.

The second layer of the laminate is bio-polybutylene succinate (PBS), a biodegradable plastic that decomposes into water and carbon dioxide with the microorganism in home composting. The succinic acid is derived from natural resources and 1,4-butanediol. Bio-PBS has a high heat resistance and high compatibility with a fiber. MCCPP Mitsubishi is a suitable supplier.

Preferably the film is approximately 0.65-1.25 mil and the PBS is 3.0-4.25 mil. In one embodiment, the laminate the film totals approximately 3.25 mil/100 microns thick. In this embodiment, the film is 0.75 mil and the PBS is 2.5 mil. In another embodiment, the laminate film totals approximately 4 mil, where the film is 0.75 mil and the PBS is 3.25 mil. Both of these thickness comply with a child resistance regulation mandating a minimum thickness.

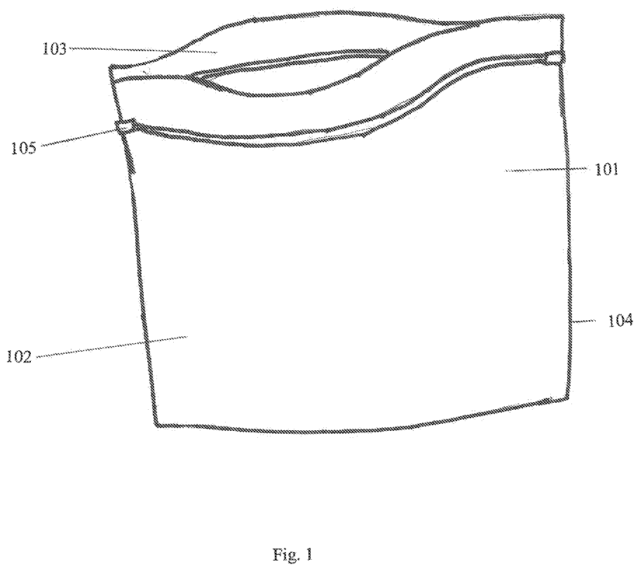

As shown in FIG. 1, a bag 101 may be formed from of two sides 102, 103 of laminated layers. The sides are sealed together on all edges 104 except one. The unsealed edge may be left open or may have a zipper closure 105 added.

The zipper closure is also biodegradable and compostable. Presto/Reynolds Group is a suitable supplier. Pouches and bags may come in a variety of sizes to suit any need.

This packaging is ideal for a consumer to use once and dispose in a home composting environment without concern of added environmental burden. It is cost-effective compared to other non-biodegradable non-compostable options.

It will be appreciated that the disclosure is not restricted to the particular embodiment that has been described, and that variations may be made therein without departing from the scope of the disclosure as defined in the appending claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

What is claimed is:

1. A compostable laminate bag substantially free of virgin petroleum-based compounds and aliphatic-aromatic polymers, the bag comprising:
(a) a first layer of biodegradable, compostable film with a 0.65-1.25 mil thickness;
(b) a second layer of biodegradable, compostable resin with a 3.0-4.25 thickness;
where the first layer and the second layer are heat laminated together to form a sheet, and sealing edges of at least one sheet are sealed closed while preserving a mouth edge on the sheet.

2. The bag of claim 1, where
(a) the first layer is approximately 0.75 mil thick, and
(b) the second layer is approximately 2.5 mil thick.

3. The bag of claim 1, where
(a) the first layer is approximately 0.75 mil thick, and
(b) the second layer is approximately 3.24 mil thick.

4. The bag of claim 1, further comprising a biodegradable, compostable zipper affixed on each side of the mouth edge.
